(19) United States
(12) Patent Application Publication
(10) Pub. No.: US 2017/0055034 A1
(43) Pub. Date: Feb. 23, 2017

(54) AUDIO AND VIDEO PLAYER

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Wei LIU, Beijing (CN)

(21) Appl. No.: 15/241,935

(22) Filed: Aug. 19, 2016

Related U.S. Application Data
(63) Continuation of application No. PCT/CN2016/082040, filed on May 13, 2016.

(30) Foreign Application Priority Data
Aug. 21, 2015 (CN) 201510522438.0

(51) Int. Cl. H04N 21/4402; H04N 7/01

(52) U.S. Cl. CPC H04N 21/440281; H04N 7/014

(57) ABSTRACT

Embodiments of the present disclosure provide an audio and video player, which is coupled with a main signal source, an audio system and a display screen. The audio and video player includes a processor and a video format converter, wherein the processor is configured to receive audio signals of an external signal source inputted through the video format converter and/or audio signals of the main signal source, transmit the audio signals therein to the audio system and transmit the video signals therein to the video format converter, to provide the video signals to the display screen to play after the video format converter receives the video signals and converts the data format of the video signals, thus enabling the audio and video player to both have high-definition frames and the function of being suitable for executing large-scale software, so as to improve the user experience and willingness to use.

### CROSS-REFERENCE TO RELATED APPLICATIONS

This application is a continuation application of PCT international application No. PCT/CN2016/082040, filed on May 13, 2016, which is based upon and claims priority to Chinese Patent Application No. 201510522438.0, filed on Aug. 21, 2015, the entire contents of which are incorporated herein by reference.

### FIELD OF THE APPLICATION

The present disclosure relates to the field of multimedia technologies, and, more particularly, to an audio and video player.

### BACKGROUND

For a solution employed to execute audio and video playing functions, current audio and video players (such as a smart TV) can only meet the use requirements of playing videos or playing mini-games since the processing capacity of a processor thereof is low. However, for the use requirements of executing large-scale games, its processing capacity for large games is far insufficient. Therefore, if gainers want to execute operations of large-scale games through a general audio and video player, it needs to purchase an additional game machine to execute, such as Microsoft XBOX ONE or Sony PS4 for playing the large-scale games on a smart TV.

Therefore, the current audio and video player cannot meet the use requirements for one machine with multi-use, and additional device is needed, which merely increases the cost, thus resulting in poor user experience so as to reduce their willingness to use the audio and video player.

### SUMMARY

The present disclosure provides an audio and video player which addresses the problems in the related art that the use requirements for one machine with multi-use cannot be satisfied, which results in poor user experience and the reduced willingness to use the audio and video player.

The present disclosure provides an audio and video player coupled with a main signal source, an audio system and a display screen. The audio and video player includes a processor and a video format converter, wherein the processor is coupled to the audio system and the main signal source respectively; the processor is configured to receive audio signals of an external signal source inputted through the video format converter and/or audio signals of the main signal source, transmits the audio signals of the main signal source and the external signal source to the audio system and transmits video signals of the main signal source and/or the external signal source to the video format converter. The video format converter is coupled to the processor; the video format converter is configured to receive the video signals of the main signal source, convert the data format of the video signals of the main signal source, and transmit the converted video signals to the display screen.

According to the audio and video player provided by the present disclosure, such as a smart TV, the video signals received by the audio and video player are suitable to be played on the display screen through the configuration of the high-performance processor having performance indexes apparently higher than that of a general processor, and the conversion of the data format of the video signals of the main signal source by the video format converter, so that the audio and video player can not only provide a high-quality video watching function, but also has the efficacy of executing high power consumption software. Therefore for the aspect of use, the audio and video player enables users to watch high-quality videos, and can also meet the use requirements for executing large-scale games in the meantime, so that the entire audio-visual entertainment efficacy of the audio and video player is enhanced, the user experience is substantially improved, and the cost for purchasing an additional game machine is saved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a block diagram of a first embodiment of an audio and video player according to the present disclosure;

FIG. 2 is a block diagram of a second embodiment of the audio and video player according to the present disclosure; and

FIG. 3 is a block diagram of a third embodiment of the audio and video player according to the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without creative efforts shall all fall within the protection scope of the present disclosure.

The audio and video player and/or audio and video output device disclosed by the embodiments of the present disclosure is configured to transmit the video signals to the display screen, wherein the audio and video player may be, but is not limited to a TV set, such as a smart TV, while the audio and video output device may be such a video and audio device like a DVD player or a set top box externally connected to the audio and video player. The above is exemplary and explanatory only, and is not intended for limitation.

Please refer to FIG. 1. An audio and video player 10 disclosed by a first embodiment of the present disclosure is coupled with a main signal source 20, an audio system 30 and a display screen 40, wherein the main signal source 20 may be, but is not limited to a TV signal source, a signal source from the Internet or a signal source downloaded from a local end, while the audio system 30 and the display screen 40 may be, but are not limited to multimedia devices self-provided by the audio and video player 10, or multimedia devices externally and detachably connected to the audio and video player 10. The audio and video player 10 includes a processor 110, a video format converter 120 and a motion compensation frame rate converter 130, wherein the processor 110 is coupled to the video format converter 120 and the motion compensation frame rate converter 130 respectively via an I2C (Inter-Integrated Circuit) bus. Moreover, an Ethernet module 140, a wireless communication module 150, a power management module 160 and a memory module 170 which are respectively coupled to the processor 110, are configured in the audio and video player 10.

In the present disclosure, the processor 110 is a processor having a dominant frequency and a register's bit number higher than that of a general processor. For example, if the general processor has 32 bits and a dominant frequency of 1.2 GHz, then the processor 110 may be a 64-bit processor having a dominant frequency of 2-2.5 GHz, wherein this is a relative value, and any processor having performance indexes apparently higher than that of a general processor (i.e., so-called high-performance processor) is applicable to be served as the processor 110 of the audio and video player 10 in the embodiment of the present disclosure.

The processor 110 is coupled to the main signal source 20 of the audio and video player 10 and is coupled to the audio system 30 via an I2S (Inter-IC Sound) audio bus (also called as integrated circuit built-in audio bus) for receiving audio and video signals of the main signal source 20, for example, the audio and video signals transmitted to the processor 110 from one of the Ethernet module 140, the wireless communication module 150 and the memory module 170 that are configured in the audio and video player 10 and coupled to the processor 110; moreover, the processor 110 is also configured to transmit the audio signals in the received audio and video signals to the audio system 30 and transmit the video signals in the audio and video signals to the video format converter 120. Wherein, the main signal source 20 includes: audio and video signals received in wireless or wired communication modes, such as via the Ethernet module 140 or the wireless communication module 150; or audio and video data directly read from the memory module 170 or the like, and audio and video signals directly provided by the audio and video player 10 itself.

In addition, a first video format output port 111 and a processing module 112 are provided on the processor 110, wherein the processing module 112 includes a central processing unit (central processing unit, CPU) 111 and/or a graphic processing unit (graphic processing unit, GPU). While the first video format output port 111 may be, but is not limited to one of a mobile high-definition video-audio standard port (mobile high-definition link, MHL; hereinafter referred to as MHL port), an HDMI interface, a low voltage differential signaling (Low Voltage Differential Signaling, LVDS) port, a DP port (display port), an EDP port (Embedded Display Port), an MIPI DSI interface (Mobile Industry Processor Interface-Display Serial Interface, mobile industry processor and display serial interface) and combinations thereof, and the processor 110 is coupled to the corresponding port on the video format converter 120 through the first video format output port 111.

A first video format input port 121, a micro control unit (micro control unit, MCU) 122 and a second video format output port 123 are provided on the video format converter 120. The first video format input port 121, coupled to the first video format output port 111 of the processor 110, is configured to receive the video signals of the main signal source 20 from the processor 110. The second video format output port 123 is coupled to a second video format input port 131, which is provided on the motion compensation frame rate converter 130. After the data format of the video signals is converted by the video format converter 120, the second video format output port 123 is configured to transmit the converted video signals to the motion compensation frame rate converter 130.

Wherein, the data format of the first video format input port 121 of the video format converter 120 is the same as the data format of the first video format output port 111 of the processor 110, for example, both of the data formats are HDMI; the data format of the second video format output port 123 of the video format converter 120 is different from the data format of the first video format output port 111 of the processor 110, for example, the data format is V-by-One. It is to be understood that because the second video format output port 123 of the video format converter 120 and the second video format input port 131 of the motion compensation frame rate converter 130 are a video signal output port and a video signal input port with corresponding data format, therefore, the data format of the second video format input port 131 of the motion compensation frame rate converter 130 in the embodiment is also data format V-by-One.

Besides being coupled to the video format converter 120, the motion compensation frame rate converter 130, also coupled to the display screen 40, is configured to receive the converted video signals from the video format converter 120, and conduct frame rate conversion (frame rate conversion, FRC) on the converted video signals based on motion estimation and motion compensation (motion estimation and motion compensation, MEMC) principle, so as to process the converted video signals to generate high resolution and high frame rate video signals, for example, to improve the video contents with a common refresh rate of 60 Hz to video contents with a refresh rate of 120 Hz or 240 Hz, and then to transmit the high resolution and high frame rate video signals to the display screen 40 to play, thus improving the definition of motion frames.

An operation mode of the audio and video player 10 disclosed by the first embodiment of the present disclosure will be illustrated hereinafter through a specific implementation manner.

After receiving the audio and video signals from the main signal source 20, the processor 110 of the audio and video player 10 transmits the audio signals in the audio and video signals to the audio system 30 through an I2S audio bus; and transmits the video signals in the audio and video signals to the video format converter 120 through the first video format output port 111. During this transmitting process, the processor 110 optionally converts the data format of the video signals into a data format applicable to the first video format output port 111 according to actual requirements s, such as HDMI, and then transmits the video signals to the video format converter 120 through the first video format output port 111.

The video format converter 120, after receiving the foregoing video signals through the first video format input port 121, converts the data format of the video signals into data format V-by-One from data format HDMI, and then transmits the converted video signals to the motion compensation frame rate converter 130 through the second video format output port 123.

Next, after receiving the converted video signals through the second video format input port 131, the motion compensation frame rate converter 130 conducts motion estimation, motion compensation and frame rate conversion on the converted video signals, so that the converted video signals are processed to generate high resolution and high frame rate video signals. Then, the high resolution and high frame rate video signals are transmitted to the display screen 40 to play, thus presenting high-definition images on the display screen 40.

Therefore, in the audio and video player of the present disclosure, the audio and video player is enabled to possess the ability of processing large-scale software, for example, large-scale games or other high power consumption software, through a manner of configuring the processor having performance indexes apparently higher than that of a general processor. Moreover, the video signals received by the processor can be played on the display screen through converting the data format of the video signals by the video format converter; and high resolution and high frame rate video signals are provided to the display screen through optimizing the converted video signals by the motion compensation frame rate converter, thus improving the quality of the display frame, and increasing the user experience in the meantime.

Furthermore, in the embodiment, the video format converter 120, on which an external audio and video input port 124 may also be optionally provided, is configured to receive external audio and video signals through the external audio and video input port 124 in the case that the audio and video player 20 is externally connected with other audio and video related device, wherein the operation mode thereof is elaborated as follows.

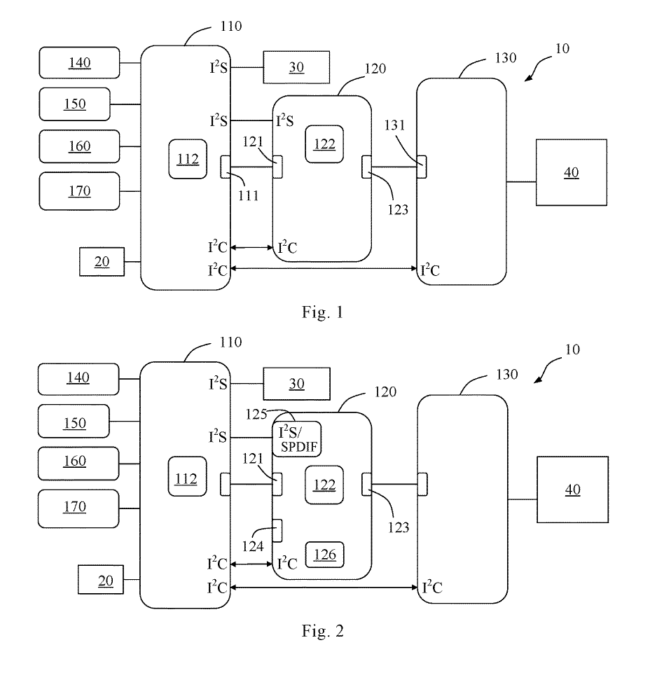

FIG. 2 is a block diagram of the audio and video player 10 disclosed by a second embodiment of the present disclosure. The second embodiment disclosed by the present disclosure is approximately the same with the first embodiment in system architecture, while the differences is that the external audio and video input port 124 and an audio output port 125 are also provided on the video format converter 120 in the audio and video player 10 disclosed by the second embodiment of the present disclosure, wherein the external audio and video input port 124 is configured to be coupled to the external signal source of such audio and video output device as a DVD player or set top box, to receive the audio and video signals of the external signal source from the audio and video output device. Therefore, the data format of the external audio and video input port 124 may be, but is not limited to such data format like an MHL port, an HDMI interface, an LVDS port, a DP port, an EDP port or an MIPI DSI interface, or the combinations of the foregoing data formats. While the audio output port 125, coupled to the processor 110 through an I2S bus, transmits the audio signals to the processor 110 after the format of the audio signals in the audio and video signals of the received external signal source is converted by the video format converter 120, to provide the audio signals to the audio system 30 to play. For example, after the data format of the audio signals is converted from HDMI to I2S, the signals are transmitted to the processor 110 through an I2S bus; or in some cases, the data format of the audio signals is converted from HDMI to SPDIF, then converted from SPDIF to I2S, and then transmitted to the processor 110.

Furthermore, the video format converter 120 also converts the data format of the video signals in the audio and video signals of external signal source, for example, from data format HDMI to data format V-by-One, so that the data format of the video signals comply with the output format of the second video format output port 123, to transmit the converted video signals in the audio and video signal to the motion compensation frame rate converter 130 for high resolution and/or high frame rate processing. For example, if the resolution of the video signals is maximum resolution, resolution processing is not conducted in this case; on the contrary, the resolution of the video signals is processed into maximum resolution if the resolution is not maximum resolution. For example, when the inputted video signals have 4K*2K resolution, then the video signals are not processed; if the inputted video signals have 1080 P resolution only, then the video signals are processed to have 4K*2K resolution, and then transmitted to the display screen 40.

Therefore, in the audio and video player disclosed by the second embodiment of the present disclosure, the video format converter 120 may optionally receive the internal video signals from the processor 110 through the first video format input port 121; or receive the external audio and video signals from the exterior of the audio and video player 10 through the external audio and video input port 124, and select corresponding processing mode according to different signal sources.

Wherein, when the video signals are from the main signal source 20, the processing mode adopted by the video format converter 120 is the same as that disclosed by the first embodiment, and will not be elaborated herein. When the signal source is from such external audio and video output device as a DVD player or a set top box or the like, the video format converter 120 receives the audio and video signals of the external signal source through the external audio and video input port 124, and the video format converter 120 converts the data format of the audio and video signals, for example, converts the data format of the audio signals in the audio and video signals from HDMI to I2S, and then transmits the signals to the processor 110, to provide the signals to the audio system 30 to play; and converts the video signals in the audio and video signals from data format HDMI to data format V-by-One, then transmits the signals to the motion compensation frame rate converter 130, and the motion compensation frame rate converter 130 processes the converted video signals to generate high resolution and high frame rate video signals, and then transmits the signals to the display screen 40, thus being capable of presenting high-definition frames on the display screen 40 similarly when an audio and video output device like a DVD player or a set top box is externally connected.

In addition, in the second embodiment of the present disclosure, an on screen display menu (on screen display, OSD) function module 126 may also be optionally provided on the video format converter 120, which is communicated with the processor 110 through an I2C bus and configured to produce corresponding OSD menu data according to an instruction of the processor 110. Therefore, in a scenario of using a menu, the processor 110 controls the OSD menu function module 126 of the video format converter 120 to produce OSD menu data according to an external input instruction, for example, in the scenario that the audio and video player 10 of the present disclosure is a TV set, a function instruction requesting for displaying a control menu is transmitted to the processor 110 through a remote controller, then the processor 110 inform the OSD menu function module 126 of the video format converter 120 to produce corresponding OSD menu data according to the function instruction, the video format converter 120 superimposes the OSD menu data onto the external video signals , and converts the data format of the superimposed external video signals. Then, the signals are transmitted to the motion compensation frame rate converter 130 and processed to generate high resolution and high frame rate video signals, to present high-definition frames and control menu on the display screen 40 simultaneously.

It should be noted that in the audio and video player of the present disclosure, if the distance between the processor and the video format converter is close and long-distance signal wire routing is not needed, or the motion compensation frame rate converter is not used, the function of the motion compensation frame rate converter may be closed, or the configuration of the motion compensation frame rate converter may be omitted.

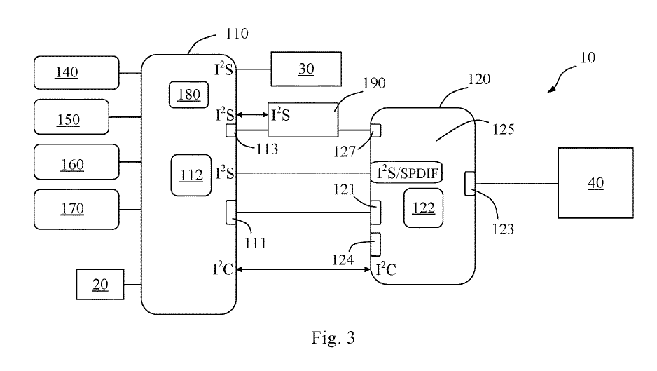

As shown in FIG. 3, in a third embodiment disclosed by the present disclosure, an audio and video player 10 includes a processor 110 and a video format converter 120. The processor 110, coupled to the main signal source 20, and coupled to an audio system 30 through an I2S audio bus and coupled to the video format converter 120 through an I2C bus, is configured to receive audio signals of an external signal source inputted through the video format converter 120 and/or audio signals of a main signal source 20, and transmit the audio signals of the main signal source 20 and/or the external signal source to the audio system 30, and transmitting the video signals of the main signal source to the video format converter 120.

A first video format input port 121, a micro control unit 122, a second video format output port 123, an external audio and video input port 124 and an audio output port 125 are provided on the video format converter 120. Wherein, the first video format input port 121, coupled to the first video format output port 111 of the processor 110, is configured to receive the video signals in the main signal source 20 from the processor 110; the second video format output port 123, coupled to a display screen 40, is configured to transmit the video signals to the display screen 40 after the data format of the video signals are converted by the video format converter 120; the external audio and video input port 124 is coupled to an external signal source of such audio and video output device as a DVD player or a set top box or the like, to receive the audio and video signals of the external signal source from the audio and video output device; while the audio output port 125, coupled to the processor 110 through an I2S bus, is configured to transmit the audio signals to the processor 110 after the format of the audio signals in the audio and video signals of the received external signal source is converted by the video format converter 120, to provide the audio signals to the audio system 30 to play.

Furthermore, in the third embodiment disclosed by the present disclosure, an OSD menu function module 126 may be coupled to the video format converter 120 or coupled to the processor 110. When the OSD menu function module 126 is coupled to the video format converter 120, the entire architecture and functions thereof are the same as that of the second embodiment, and will not be elaborated herein.

In the third embodiment of the audio and video player 10 of the present disclosure, when the OSD menu function module 180 is coupled to the processor 110, a menu data output port 113 is also provided on the processor 110, and a menu data input port 127 is also provided on the video format converter 120. The menu data output port 113 and the menu data input port 127 are mutually coupled with each other, and the two may be either ports with mutually corresponding data format or ports with different data formats; wherein, if the data format of the menu data output port 113 is different from that of the menu data input port 127, then a menu data format converter 190, also coupled between the processor 110 and the video format converter 120, is configured to convert the data format of the OSD menu data into a data format suitable to be received by the video format converter 120.

Therefore, in operation, after the processor receives a function instruction of requesting for displaying the control menu, the processor 110 controls the OSD menu function module 180 to produce corresponding OSD menu data according to the function instruction, and then directly transmits the data to the video format converter 120 through the menu data output port 113 and the menu data input port 127; or, the menu data format converter 190 converts the data format of the OSD menu data firstly, and then transmits the converted data to the video format converter 120, the video format converter 120 superimposes the OSD menu data onto the video signals of the external signal source, and converting the data format of the superimposed video signals. Then, the signals are transmitted to the display screen 40 to play.

It may be understood by those having ordinary skills in the art that the all or a part of steps of implementing the foregoing embodiments may be finished through relevant hardware instructed by a program. The program may be stored in a computer readable storage medium, and the program while performing includes the steps of the foregoing embodiments of the method. While the aforementioned storage medium includes: various mediums that can store program codes such as ROM, RAM, magnetic disk or optical disk.

It should be finally noted that all the embodiments above are only to explain the technical solutions of the present disclosure, but are not intended to limit the protection scope of the present disclosure. Although the present disclosure has been illustrated in detail according to the foregoing embodiments, those having ordinary skills in the art should understand that modifications can still be done to the technical solutions recited in various embodiments described above, or equivalent substitutions can still be done to a part or whole of technical features thereof, and these modifications or substitutions will not depart the essence of the corresponding technical solutions from the scope of the technical solutions of various embodiments of the present disclosure.

What is claimed is:

1. An audio and video player , coupled with a main signal source, an audio system and a display screen, wherein the audio and video player comprises: a processor and a video format converter, wherein,
the processor is coupled to the audio system and the main signal source, respectively; the processor is configured to receive audio signals of an external signal source inputted from the video format converter and/or audio signals of the main signal source; the processor is configured to transmit the audio signals of the main signal source and/or the external signal source to the audio system; the processor is configured to transmit the video signals of the main signal source and/or the external signal source to the video format converter; and
the video format converter is coupled to the processor; the video format converter is configured to receive the video signals of the main signal source, convert the data format of the video signals of the main signal source, and transmit the converted video signals to the display screen.

2. The audio and video player according to claim 1, further comprising:
a motion compensation frame rate converter, coupled between the video format converter and the display screen, and configured to receive the converted video signals, process the converted video signals to generate high resolution and high frame rate video signals, and transmit the high resolution and high frame rate video signals to the display screen.

3. The audio and video player according to claim 2, wherein,
a first video format output port is provided on the processor;
a second video format input port is provided on the motion compensation frame rate converter; and
a first video format input port and a second video format output port are provided on the video format converter;
wherein, the first video format input port, coupled to the first video format output port, is configured to receive the video signals of the main signal source; and the second video format output port, coupled to the second video format input port, is configured to transmit the converted video signals to the motion compensation frame rate converter.

4. The audio and video player according to claim 3, wherein an external audio and video input port is provided on the video format converter, which is coupled to the external signal source ;and the external audio and video input port is configured to receive the audio and video signals of the external signal source, wherein the video format converter is configured to transmit the audio signals in the audio and video signals to the processor, and the processor is configured to transmit the audio signals to the audio system; and the video format converter is configured to convert the data format of the video signals in the audio and video signals, and transmit the converted video signals in the audio and video signal to the motion compensation frame rate converter.

5. The audio and video player according to claim 4, wherein an audio output port is provided on the video format converter, which is configured to transmit the audio signals in the audio and video signals to the processor, wherein the processor is coupled to the audio output port and the audio system via an I2S audio bus, respectively.

6. The audio and video player according to claim 4, wherein the video format converter or the processor is further coupled with an on screen display menu function module, which is configured to produce on screen display menu data, wherein the processor controls the on screen display menu function module to produce on screen display menu data according to an external input instruction, and the video format converter is further configured to superimpose the on screen display menu data onto the video signals in the audio and video signals, and convert the data format of the superimposed video signals.

7. The audio and video player according to claim 6, wherein a menu data format converter is further coupled between the processor and the video format converter optionally when the processor is coupled with the on screen display menu function module, and is configured to convert the data format of the on screen display menu data into a data format suitable for being received by the video format converter.

8. The audio and video player according to any one of claims 3 to 5, wherein the data format of the first video format output port and the external audio and video input port is one of MHL, HDMI, LVDS, DP, EDP, MIPI DSI and combinations thereof, the data format of the first video format input port is the same as the data format of the first video format output port, the data format of the second video format output port is different from the data format of the first video format output port, and the second video format output port and the second video format input port are a video signal output port and a video signal input port with corresponding data format.

9. The audio and video player according to claim 8, wherein the data format of the second video format output port is V-by-One.

10. The audio and video player according to claim 1, wherein the audio and video player is a TV set, the main signal source is a TV signal source, a signal source from Internet or a signal source downloaded locally, and the external signal source is an audio and video signal source of a video and audio device externally connected to the audio and video player.
